(19) United States
(12) Patent Application Publication
(10) Pub. No.: US 2012/0223917 A1
(43) Pub. Date: Sep. 6, 2012

(54) Position Indicator

(75) Inventor: Shun-Pin Lin, New Taipei City (TW)

(73) Assignees: SUNREX TECHNOLOGY CORP., Taichung City (TW); UC-LOGIC TECHNOLOGY CORP., New Taipei City (TW); GIMBAL TECHNOLOGY CO., LTD., New Taipei City (TW)

(21) Appl. No.: 13/216,502

(22) Filed: Aug. 24, 2011

(30) Foreign Application Priority Data
Mar. 3, 2011 (TW) 100107123

(51) Int. Cl. G06F 3/033

(52) U.S. Cl. 345/179

(57) ABSTRACT

A position indicator is for use with a wireless platform operable to wirelessly transmit an excitation signal and to determine position of the position indicator relative to the wireless platform according to an oscillation signal received by the wireless platform. The position indicator includes: a working unit disposed in a casing unit, and operable to receive the excitation signal via a receiver coil, to generate the oscillation signal from the excitation signal, and to wirelessly transmit the oscillation signal via a transmitter coil; and a trigger unit disposed in the receiving space, and including a core part having first and second sections that correspond respectively in position to the transmitter and receiver coils, the first section of the core part having a varying permeability value, the second section of the core part having a substantially non-varying permeability value.

### CROSS-REFERENCE TO RELATED APPLICATION

This application claims priority of Taiwanese Application No. 100107123, filed on Mar. 3, 2011.

### BACKGROUND OF THE INVENTION

1. Field of the Invention

The present invention relates to a position indicator suitable for use with a wireless platform, such as a digital tablet.

2. Description of the Related Art

There are many data input methods available for computers. One known method adopts the combination of a digital stylus and a digital tablet. Such an input method is generally used in drawing applications and handwriting applications. During operation, the digital stylus is operable to generate a wireless signal for receipt by the digital tablet, whereby position of the digital stylus relative to the digital tablet may be obtained according to the wireless signal received by the digital tablet.

There are several methods to power the digital stylus. One of the methods is to power the digital stylus using a battery module. However, a digital stylus thus powered generally has the drawbacks of regular battery replacement and larger dimensions. Another of the methods is to power the digital stylus with power generated from signals that are received from the digital tablet. However, a digital stylus thus powered generally has the drawbacks of relatively long position update intervals since the same coil unit in the digital stylus is used for receiving and transmitting signals from and to the digital tablet.

Taiwanese Patent No. M390495 discloses a digital stylus that includes one coil unit for receiving signals from the digital tablet, and another coil unit for transmitting signals to the digital tablet, thereby achieving relatively short position update intervals. However, the digital stylus has several drawbacks:

1) Since the digital stylus includes two coil units, the digital stylus has a relatively complex structure and a higher production cost.

2) Power generated by the digital stylus fluctuates due to variation in distance between the digital tablet and the digital stylus.

### SUMMARY OF THE INVENTION

Therefore, an object of the present invention is to provide a position indicator capable of alleviating the aforesaid drawbacks of the prior art.

A position indicator of the present invention is for use with a wireless platform that is operable to wirelessly transmit an excitation signal and to determine position of the position indicator relative to the wireless platform according to an oscillation signal received by the wireless platform. The position indicator includes:

a casing unit having opposite first and second ends, and formed with a first through hole at the first end thereof, and a receiving space that extends from the first end toward the second end along an axis and that is in spatial communication with the first through hole;

a working unit disposed in the receiving space, and including

a wireless receiver module including a receiver coil, and operable to receive the excitation signal via the receiver coil thereof, and to generate an alternating current (AC) power signal from the excitation signal received thereby,

a power converter module connected electrically to the wireless receiver module for receiving the AC power signal therefrom, and operable to generate a direct current (DC) power signal from the AC power signal received thereby, and

a wireless transmitter module connected electrically to the power converter module for receiving the DC power signal therefrom, including a transmitter coil, and operable to generate the oscillation signal from the DC power signal received thereby, and to wirelessly transmit the oscillation signal via the transmitter coil thereof, the transmitter coil and the receiver coil being disposed to surround and being arranged along the axis; and

a trigger unit disposed in the receiving space, and including

a core part including

a one-piece body portion extending through the transmitter coil and the receiver coil, and having first and second sections that correspond respectively in position to the transmitter coil and the receiver coil, the first section of the body portion having a permeability value that varies along the axis, the second section of the body portion having a permeability value that is substantially non-varying along the axis, and

a tip portion that extends through the first through hole and that is connected to the body portion, and

a resilient part that abuts against the body portion and that is disposed such that the body portion is interposed between the tip portion and the resilient part.

Application of pressure to the tip portion results in movement of the core part in the receiving space along the axis, compressing of the resilient part, movement of the first section of the body portion with respect to the transmitter coil that results in a corresponding change in an inductance value of the transmitter coil attributed to the varying permeability value of the first section of the body portion, and movement of the second section of the body portion with respect to the receiver coil that results in substantially no change in an inductance value of the receiver coil attributed to the substantially non-varying permeability value of the second section of the body portion.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of the preferred embodiment of a position indicator according to the present invention;

FIG. 2 is a sectional view of the position indicator and a wireless platform showing the position indicator in one position;

FIG. 3 is a circuit diagram of the position indicator; and

FIG. 4 is another sectional view of the position indicator and the wireless platform showing the position indicator in another position.

### DETAILED DESCRIPTION OF THE PREFERRED EMBODIMENT

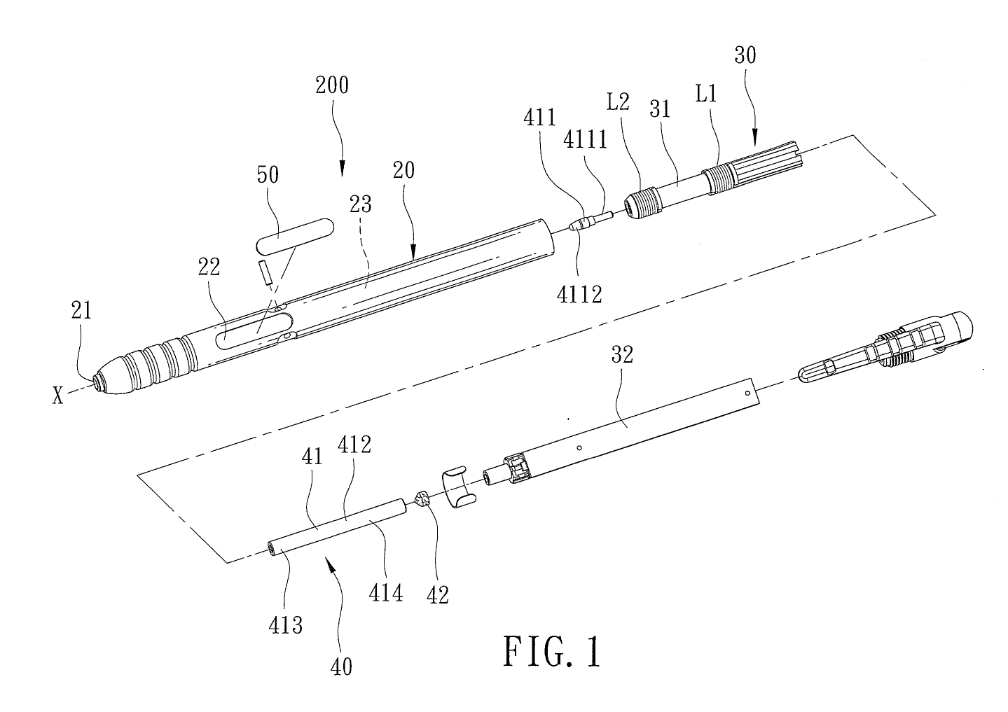

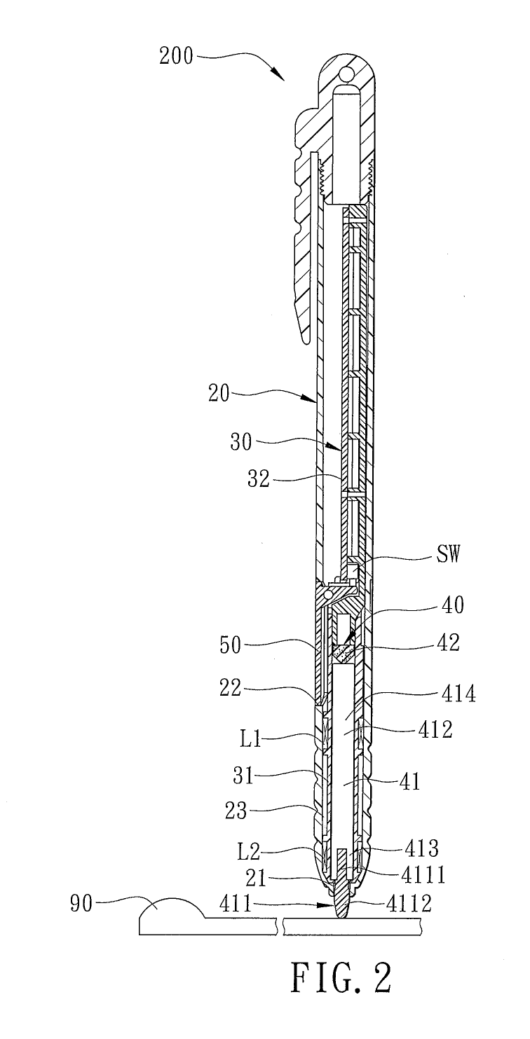

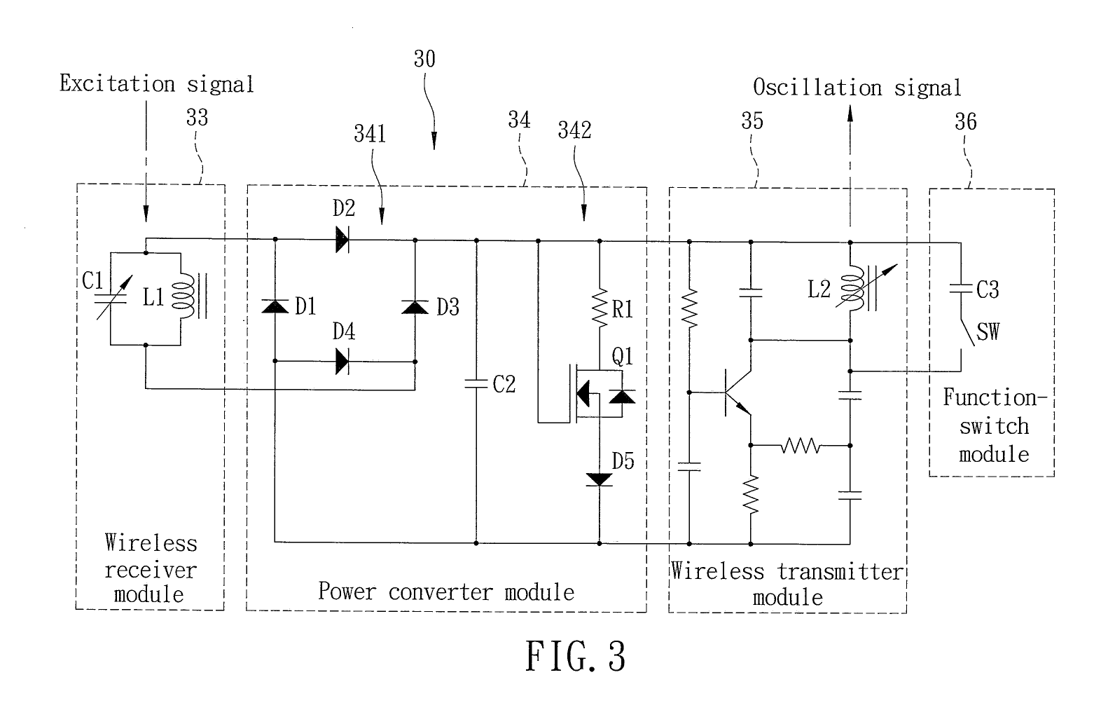

Referring to FIGS. 1 to 3, the preferred embodiment of a position indicator 200 according to the present invention is for use with a wireless platform such as a digital tablet 90, which is operable to generate an excitation signal, to wirelessly transmit the excitation signal, to wirelessly receive an oscillation signal, and to determine position of the position indicator 200 relative to the digital tablet 90 according to the oscillation signal received by the digital tablet 90.

The position indicator 200 includes a casing unit 20, a working unit 30, and a trigger unit 40.

The casing unit 20 has the form of a stylus barrel in this embodiment, has opposite first and second ends, is formed with a first through hole 21 at the first end thereof, a second through hole 22 at a lateral side thereof, and a receiving space 23 that extends from the first end toward the second end of the casing unit 20 along an axis “X” and that is in spatial communication with the first and second through holes 21, 22. The position indicator 200 further includes a function key 50 corresponding in shape to the second through hole 22, disposed on the casing unit 20 at the second through hole 22, and accessible externally of the casing unit 20.

The working unit 30 is disposed in the receiving space 23, and includes a spool 31, a substrate 32, a wireless receiver module 33, a power converter module 34, a wireless transmitter module 35, and a function-switch module 36.

The spool 31 extends along the axis “X” and is secured in the receiving space 23 of the casing unit 20. In this embodiment, the substrate 32 is connected to the spool 31.

The wireless receiver module 33 includes a receiver coil “L1” and a variable capacitor “C1” that are connected in parallel and that correspond to a resonance frequency, which may be adjusted through adjusting the variable capacitor “C1” to match frequency of the excitation signal. In such a configuration, the wireless receiver module 33 is operable to generate an alternating current (AC) power signal from the excitation signal received thereby.

The power converter module 34 is connected electrically to the wireless receiver module 33 for receiving the AC power signal therefrom, and is operable to generate a direct current (DC) power signal from the AC power signal received by the wireless receiver module 33. In this embodiment, the power converter module 34 includes a rectifier circuit 341 and a voltage regulating circuit 342.

The rectifier circuit 341 includes a plurality of diodes D1-D4 and a capacitor “C2” that cooperate to rectify the AC power signal so as to generate an intermediate signal. The voltage regulating circuit 342 includes a transistor “Q1”, a resistor “R1”, and a diode “D5” that cooperate to regulate voltage of the intermediate signal so as to generate the DC power signal.

When voltage of the intermediate signal exceeds a predetermined voltage value, which, in this embodiment, is the summation of a threshold voltage value of the transistor “Q1” and a forward bias voltage value of the diode “D5”, the transistor “Q1” and the diode “D5” will enter a conductive state, thereby regulating voltage of the DC power signal to fall within a predetermined voltage range.

The wireless transmitter module 35 is connected electrically to the power converter module 34 for receiving the DC power signal therefrom, includes a transmitter coil “L2”, and is operable to generate the oscillation signal from the DC power signal received thereby, and to wirelessly transmit the oscillation signal via the transmitter coil “L2”. In this embodiment, the wireless transmitter module 35 is realized using an oscillator circuit, such as a Colpitts Oscillator.

The function-switch module 36 includes a series connection of a switch “SW” and a capacitor “C3”, the series connection being connected electrically to the transmitter coil “L2” of the wireless transmitter module 35. The switch “SW” is driven by the function key 50 to make or break electrical connection between the capacitor “C3” and the transmitter coil “L2”, such that frequency of the oscillation signal generated by the wireless transmitter unit 35 is varied according to an operational state of the function key 50. The digital tablet 90 may be configured to perform predetermined functions according to the frequency of the oscillation signal received thereby.

In this embodiment, the receiver coil “L1” and the transmitter coil “L2” are wound on the spool 31, and are disposed to surround and are arranged along the axis “C”.

wireless receiver module 33, the power converter module 34, the wireless transmitter module 35, and the function-switch module 36 have components other than the receiver coil “L1” and the transmitter coil “L2” disposed on the substrate 32. The coils “L1”, “L2” are resonant in respective non-overlapping frequency bands, such that interference between the excitation and oscillation signals is relatively reduced. In this embodiment, the frequency band in which the receiver coil “L1” is resonant has higher frequencies relative to the frequency band in which the transmitter coil “L2” is resonant.

The trigger unit 40 is disposed in the receiving space 23, and includes a core part 41 and a resilient part 42.

The core part 41 is substantially disposed in the spool 31, and has a tip portion 411 and a one-piece body portion 412. The body portion 412 extends through the receiver coil “L1”, and the transmitter coil “L2”, and has first and second sections 413, 414 that correspond in position to the transmitter coil “L2” and the receiver coil “L1”, respectively. In this embodiment, the body portion 412 has a first end that is proximate to the first end of the casing unit 20 and that is formed with a socket, and a second end that is opposite to the first end. The first section 413 is disposed at the first end of the body portion 412, is made of a magnetically permeable material, and has a permeability value that varies along the axis “X”. The second section 414 is disposed at the second end of the body portion 412, is made of a magnetically permeable material, and has a permeability value that is substantially non-varying along the axis “X”.

The tip portion 411 has a connecting section 4111 that extends into the transmitter coil “L2” and that is coupled to the body portion 412, and a writing section 4112 that extends from the connecting section 4111 through the first through hole 21. In this embodiment, the tip portion 411 is made of a plastic material (e.g., polyacetal).

In this embodiment, the first and second sections 413, 414 of the body portion 412 are integrally connected.

The resilient part 42 is secured between the spool 31 and the substrate 32, abuts against the body portion 412, and is disposed such that the body portion 412 is interposed between the tip portion 411 and the resilient part 42.

Operation of the position indicator 200 is described hereinafter.

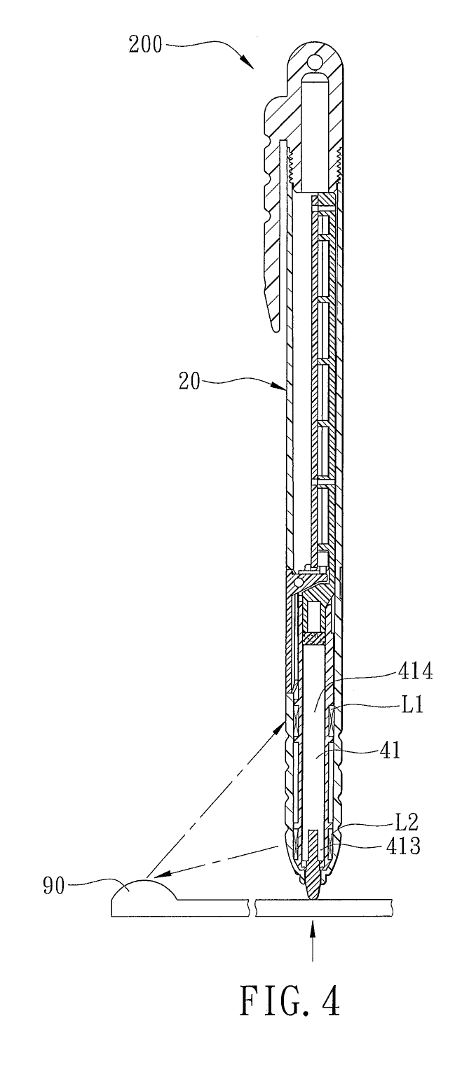

When the position indicator 200 is pressed against the digital tablet 90, an increase in pressure between the tip portion 411 and the digital tablet 90 results in movement of the core part 41 in the receiving space 23 along the axis “X”, compressing of the resilient part (see FIG. 4), movement of the first section 413 of the body portion 412 with respect to the transmitter coil “L2” that results in a corresponding change in an inductance value of the transmitter coil “L2” attributed to the varying permeability value of the first section 413 of the body portion 412, and movement of the second section 414 of the body portion 412 with respect to the receiver coil “L1” that results in substantially no change in an inductance value of the receiver coil “L1” attributed to the substantially non-varying permeability value of the second section 414 of the body portion 412.

Moreover, variation in pressure between the tip portion 411 of the core part 41 and the digital tablet 90 is reflected through variation in frequency of the oscillation signal. In this embodiment, the position indicator 200 is configured such that pressure between the tip portion 411 of the core part 41 and the digital tablet 90 is in a negative relation to the inductance value of the transmitter coil “L2”, and is in a positive relation to frequency of the oscillation signal.

In summary, the position indicator 200 of the present invention has a relatively simple structure, where the coils “L1”, “L2” are wound around the core part 41, and has relatively low production cost and difficulty. During operation, the power converter module 34 is able to generate stably the DC power signal from the AC power signal, and the coil “L2” cooperates with the first section 413 of the body portion 412 of the core part 41 to increase magnitude of frequency variation of the oscillation signal, which facilitates determination of relative position of the position indicator 200 by the digital tablet 90.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A position indicator for use with a wireless platform that is operable to wirelessly transmit an excitation signal and to determine position of said position indicator relative to the wireless platform according to an oscillation signal received by the wireless platform, said position indicator comprising:
a casing unit having opposite first and second ends, and formed with a first through hole at said first end thereof, and a receiving space that extends from said first end toward said second end along an axis and that is in spatial communication with said first through hole;
a working unit disposed in said receiving space, and including
a wireless receiver module including a receiver coil, and operable to receive the excitation signal via said receiver coil thereof, and to generate an alternating current (AC) power signal from the excitation signal received thereby,
a power converter module connected electrically to said wireless receiver module for receiving the AC power signal therefrom, and operable to generate a direct current (DC) power signal from the AC power signal received thereby, and
a wireless transmitter module connected electrically to said power converter module for receiving the DC power signal therefrom, including a transmitter coil, and operable to generate the oscillation signal from the DC power signal received thereby, and to wirelessly transmit the oscillation signal via said transmitter coil thereof, said transmitter coil and said receiver coil being disposed to surround and being arranged along the axis; and
a trigger unit disposed in said receiving space, and including
a core part including
a one-piece body portion extending through said transmitter coil and said receiver coil, and having first and second sections that correspond respectively in position to said transmitter coil and said receiver coil, said first section of said body portion having a permeability value that varies along the axis, said second sect ion of said body portion having a permeability value that is substantially non-varying along the axis, and
a tip portion that extends through said first through hole and that is connected to said body portion, and
a resilient part that abuts against said body portion and that is disposed such that said body portion is interposed between said tip portion and said resilient part;
wherein application of pressure to said tip portion results in movement of said core part in said receiving space along the axis, compressing of said resilient part, movement of said first section of said body portion with respect to said transmitter coil that results in a corresponding change in an inductance value of said transmitter coil attributed to the varying permeability value of said first section of said body portion, and movement of said second section of said body portion with respect to said receiver coil that results in substantially no change in an inductance value of said receiver coil attributed to the substantially non-varying permeability value of said second section of said body portion.

2. The position indicator as claimed in claim 1, wherein said casing unit is further formed with a second through hole in a lateral side thereof, said second through hole being in spatial communication with said receiving space, said position indicator further comprising a function key disposed on said casing unit at said second through hole and accessible externally of said casing unit, said working unit further including a function-switch module operatively associated with said wireless transmitter module of said working unit and said function key such that frequency of the oscillation signal generated by said wireless transmitter module is varied according to an operational state of said function key.

3. The position indicator as claimed in claim 2, wherein said function-switch module includes a series connection of a switch and a capacitor, the series connection being connected to said wireless transmitter module, said switch being driven by said function key to make or break electrical connection between said capacitor and said wireless transmitter module.

4. The position indicator as claimed in claim 1, wherein said working unit further includes a spool extending along the axis, said transmitter coil and said receiver coil being wound on said spool, said body portion of said core unit extending in said spool.

5. The position indicator as claimed in claim 4, wherein said working unit further includes a substrate connected to said spool, said resilient part being secured between said spool and said substrate, said wireless transmitter module, said power converter module, and said wireless receiver module having components other than said transmitter coil and said receiver coil disposed on said substrate.

6. The position indicator as claimed in claim 1, wherein said first section of said body portion is disposed at one end of said body portion proximate to said first end of said casing unit, said tip portion including a connecting section that extends into said transmitter coil and that is coupled to said body portion.

7. The position indicator as claimed in claim 6, wherein said tip portion is made of a plastic material.

8. The position indicator as claimed in claim 6, wherein said first and second sections of said body portion are integrally connected, and each of said first and second sections is made of a magnetically permeable material.

9. The position indicator as claimed in claim 1, wherein said transmitter coil and said receiver coil are resonant in respective non-overlapping frequency bands.

10. The position indicator as claimed in claim 9, wherein the frequency band in which said receiver coil is resonant has higher frequencies relative to the frequency band in which said transmitter coil is resonant.

11. The position indicator as claimed in claim 1, wherein said wireless receiver module further includes a variable capacitor coupled in parallel to said receiver coil, said receiver coil and said variable capacitor defining a resonant frequency corresponding to the oscillation signal.

12. The position indicator as claimed in claim 1, wherein said wireless transmitter module includes an oscillator circuit.

13. The position indicator as claimed in claim 1, wherein said power converter module includes a rectifier circuit and a voltage regulating circuit.
